(19) United States
(12) Patent Application Publication
(10) Pub. No.: US 2013/0107198 A1
(43) Pub. Date: May 2, 2013

(54) EYEWEAR FOR LIMITING WANDERING VISION

(71) Applicant: John Schepers, Guelph (CA)

(72) Inventor: John Schepers, Guelph (CA)

(21) Appl. No.: 13/658,539

(22) Filed: Oct. 23, 2012

Related U.S. Application Data
(60) Provisional application No. 61/554,599, filed on Nov. 2, 2011.

(51) Int. Cl. G02C 7/16

(52) U.S. Cl. 351/111; 351/159.6

(57) ABSTRACT

Eyewear for wearing on a person's head, the eyewear having a lens section for positioning in front of the wearer's eyes, wherein part of the lens section allows viewable light to pass through and part of the lens section blocks viewable light from passing through thereby focusing the wearer's attention away from regions of a viewed person.

### BACKGROUND

The present disclosure relates to eyewear.

### SUMMARY

According to an example embodiment, there is provided eyewear for wearing on a person's head, the eyewear having a lens section for positioning in front of the wearer's eyes, wherein part of the lens section allows viewable light to pass through and part of the lens section blocks viewable light from passing through thereby focusing the wearer's attention away from regions of a viewed person.

According to another example embodiment there is provided glasses for wearing on a person's head, the glasses having right and left lenses for positioning in front of the wearer's left and right eyes respectively, each lens having an upper region through which viewable light can pass to be viewed by the wearer and a lower region blocking viewable light.

### BRIEF DESCRIPTION OF THE FIGURES

FIG. 1 shows a representation of a person viewed normally;

FIG. 2 is a front perspective view of eyewear according to an example embodiment; and

FIG. 3 is a representation of a person viewed through the eyewear of FIG. 2.

### DETAILED DESCRIPTION

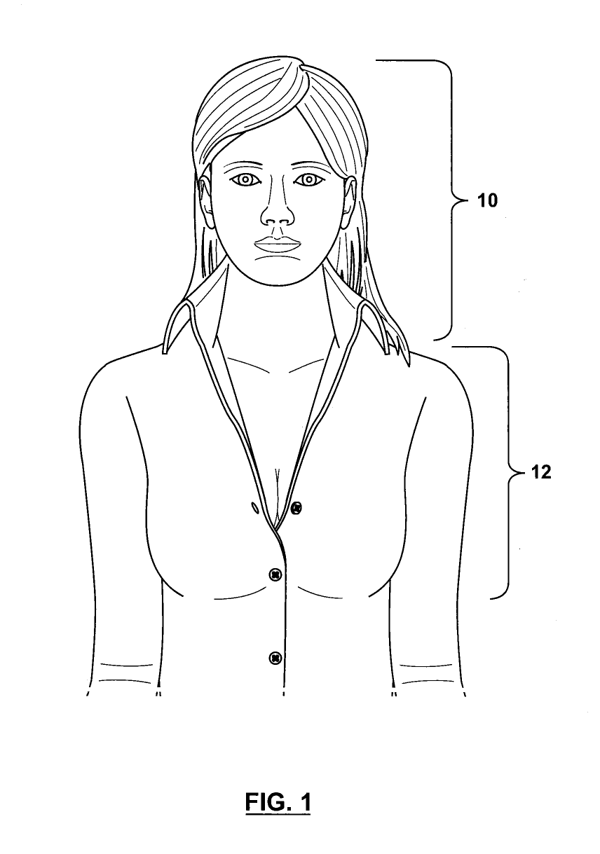

When engaged in a conversation, maintaining visual contact with the face and eyes of the other person is generally considered a positive behaviour and allows one to focus on what the other person is saying as well as pick up on important non-verbal facial communications from the other person. Unfortunately, perhaps as a result of evolution and/or as a result of being subjected to repeated images in the mass media, as many as fifty percent of the human population at least some time during their lives may have at least a subconscious urge to divert their visual attention from the facial region of the person they are in conversation with to other regions of that person's body. By way of example, FIG. 1 illustrates a person as viewed during a conversation from the perspective of a viewing person. Maintaining eye contact with the facial region 10 of such person is generally encouraged behaviour, while diverting vision to lower regions of such person such as the chest region 12 can be distracting and embarrassing for both people in the conversation.

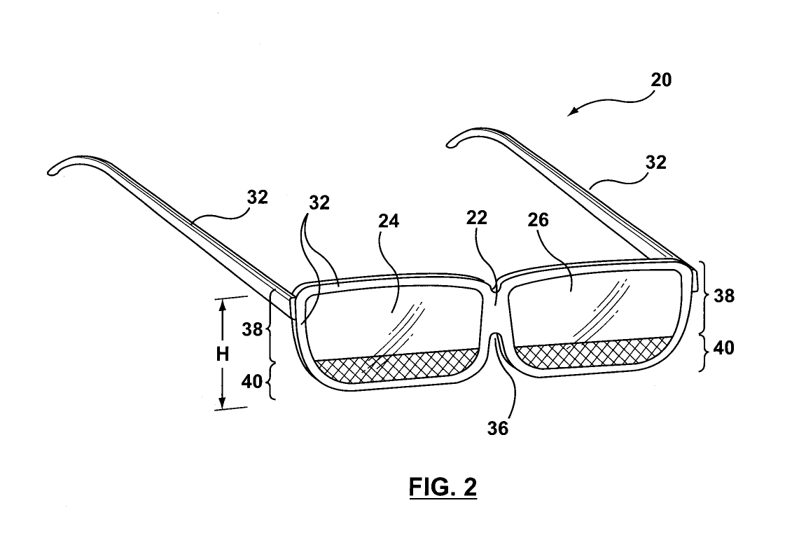

FIG. 2 illustrates eyewear 20 for at least partially addressing the problem identified above. Eyewear 20 is similar to conventional eyewear or glasses in that it includes a forward facing lens section 22 from which two spaced-apart arms 32 extend in a rearward direction. The lens section 22 includes a nose region 36 for resting on a wearer's nose while the spaced-apart arms 32 engage the ears of the wearer and/or the opposite sides of the wearer's head. The arms 32 may be attached to the lens section 22 by hinges to fold for storage, or may be fixed in place. The lens section 22 includes left lens 26 for positioning in front of the wearer's left eye and right lens 24 for positioning in front of the wearer's right eye. Left and right lens 26, 24 may for example be made from plastic or glass. The lens section 22 may include an outer frame 34 formed from plastic or metal or other material for containing the left lens 26 and right lens 24, to which the arms 32 may be connected. However, in at least some examples, the lens section 22 is frameless with the left lens 26 and right lens 24 being formed from a unitary piece of plastic material.

As can be seen in FIG. 2, in an example embodiment each of the lenses 24, 26 has an upper region 38 and a lower region 40. The upper region 38 of each lens allows viewable light to pass through—for example, the upper region could be completely transparent, translucent or tinted, or mirrored on the external surface, and/or could be configured to provide a corrective prescription. The lower region 40 of each lens, however, is opaque and in this regard is blackened or coloured or otherwise shaded to substantially block any visible light from passing therethrough. In some example embodiments, where “H” indicates the maximum height of each lens 24, 26, the height of lower region 40 is at least one-third to one-half the maximum lens height “H”. Accordingly, in the illustrated embodiment the upper region 38 that passes viewable light extends from a top distal edge of the lens 24, 26 to terminate at the lower region 40 that blocks viewable light, with the lower region 40 extending from the upper region 38 to the lower distal edge.

In some example embodiments, the light blocking lower region 40 may not extend across the entire lower region of each lens 24, 26, but rather could just extend across a central lower region. In at least some example embodiments, light blocking region 40 is located on lenses 24, 26 in the same areas in which the “near vision enhancing” portion of bifocals would normally be positioned on eyewear, and accordingly eyewear such as that shown in FIG. 2 has been named as “manfocals”™ by the inventor hereof.

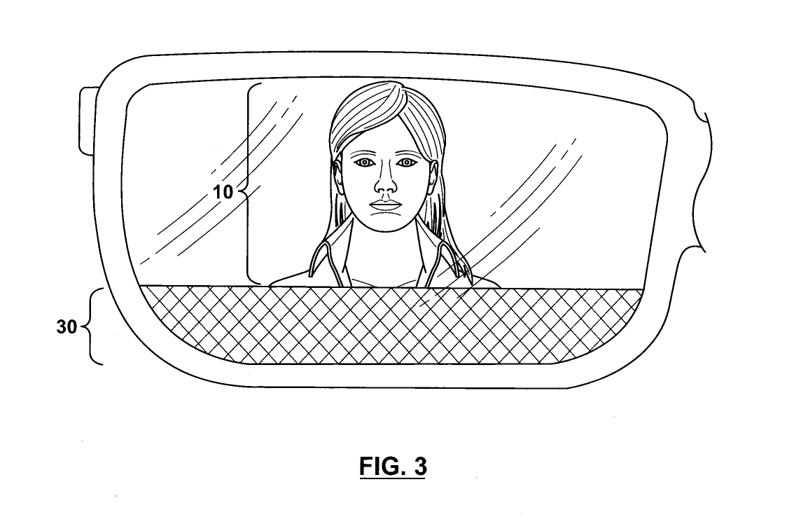

FIG. 3 schematically illustrates a view, from the perspective of a wearer of the eyewear of FIG. 2, of another person. As can be seen in FIG. 3, the light blocking lower regions 40 of lenses 24, 26 result in at least partial visual blocking 30 of the lower portion of the viewed person. As a result, the wearer's vision is focussed on the facial region 10 of the viewed person and in at least some situations, the wearer is less likely to get distracted during conversation and more likely to listen to what is being said and pay attention to non-verbal facial expressions. Embarrassment and/or miscommunications between parties may be reduced in at least some situations.

In some example embodiments, the upper and lower regions of the lens 24, 26 could be reversed so that the lower region is transparent and the upper region is opaque. Such a configuration could be useful in situations where the viewed person has a bad or otherwise distracting hair-style, or no hair, so that the wearer's attention is focussed lower on the viewed person's face than the viewed person's hairline.

It will be appreciated that example embodiments have been described above, however many different embodiments of manfocals™ are possible.

1. Eyewear for wearing on a person's head, the eyewear having a lens section for positioning in front of the wearer's eyes, wherein part of the lens section allows viewable light to pass through and part of the lens section blocks viewable light from passing through thereby focusing the wearer's attention away from regions of a viewed person.

2. The eyewear of claim 1 wherein the part of the lens section that allows viewable light to pass through is located above the part of the lens section that blocks viewable light when the eyewear is oriented in a normal wearing position such that the wearer's attention is focused on a facial region of a viewed person and away from a chest region of the viewed person.

3. The eyewear of claim 2 wherein the eyewear comprises spaced-apart arms extending from the lens section for engaging the ears of the wearer and/or the opposite sides of the wearer's head.

4. The eyewear of claim 2 wherein the lens section comprises a left lens and a right lens, an upper region of each lens being translucent or transparent and a lower region of each lens being opaque.

5. The eyewear of claim 4 wherein the lens section is formed from a unitary piece of plastic material.

6. The eyewear of claim 4 wherein the left lens and right lens are separated by a nose engaging region.

7. Glasses for wearing on a person's head, the glasses having right and left lenses for positioning in front of the wearer's left and right eyes respectively, each lens having an upper region through which viewable light can pass to be viewed by the wearer and a lower region blocking viewable light.

8. The glasses of claim 7 wherein each lens is formed from glass or plastic, the lower region being blacked out, the upper region being clear.

9. The glasses of claim 7 wherein each lens has a top distal edge and a lower distal edge, the upper region that passes viewable light extending from the top distal edge to terminate at the lower region that blocks viewable light, the lower region extending from the upper region to the lower distal edge.

10. A method for directing visual attention of a viewing person away from a chest region of a viewed person and towards a facial region of the viewed person comprising:
providing eyewear for wearing on the viewing person's head, the eyewear having a lens section for positioning in front of the viewing person's eyes, wherein an upper part of the lens section allows viewable light to pass through and a lower part of the lens section blocks viewable light from passing through thereby encouraging the viewing person's attention to be directed away from the chest region of the viewed person and towards the facial region of the viewed person.
